(19) United States
(12) Patent Application Publication
(10) Pub. No.: US 2008/0029745 A1
(43) Pub. Date: Feb. 7, 2008

(54) WINCH TOOL

(75) Inventor: Albert CHARTIER, Ste-Julienne (CA)

Correspondence Address: OSLER, HOSKIN & HARCOURT, LLP (OTHER), 1000 DE LA GAUCHETIERE STREET WEST, SUITE 2100, MONTREAL, QC, H3B-4W5, CA

(73) Assignee: NORCAN ALUMINIUM INC., Montreal (CA)

(21) Appl. No.: 11/776,330

(22) Filed: Jul. 11, 2007

Related U.S. Application Data
(60) Provisional application No. 60/806,980, filed on Jul. 11, 2006.

(51) Int. Cl. B25B 25/00

(52) U.S. Cl. 254/243

(57) ABSTRACT

A mechanism for improving the use of winches adapted for securing cargo load on flat bed trailers pulled by road tractors provides the additional capability to continuously wind a belt thereon and to remove the wound belt from the mechanism for storage. The mechanism can be part of the winch or simply temporarily fasten to the winch and is activated with the winch. The mechanism further includes a device for rapidly and continuously rotating the winch.

### CROSS REFERENCE TO REALATED APPLICATION

The present invention claims priority to U.S. provisional patent application No. 60/806,980 entitled: WINCH TOOL, filed Jul. 11, 2006, the entirety of which is incorporated herein by reference.

### FIELD OF THE INVENTION

The present invention relates to a winch tool. More specifically, the present invention is concerned with a tool and a belt support adapted for use with a winch attached to a trailer for securing cargo.

### BACKGROUND OF THE INVENTION

The trucking industry carries cargo loads on semi-trailers pulled by road tractors. Various types of trailers exist for different purposes. Enclosed trailers, flat deck or float-type trailers are among the most popular types of trailers on the road these days. The use of a flat deck trailer requires straps or belts to secure the cargo load on the flat deck. The retaining straps are disposed on the trailer according to the size and shape of the cargo load.

Several winches are usually attached on the sides of the trailer for tying the cargo load on the flat deck trailer. Each winch includes a belt that can be wound on the rotatable barrel of the winch to secure the cargo load. Common winches are strong but slow to operate because the barrel of the winch is not adapted to continuously rotate about its rotation axis. A ratchet-type mechanism is located on one axial side of the barrel to maintain tension in the belt. A removable lever, installed in a radial opening located on the other axial side of the rotatable barrel, actuates the ratchet-type mechanism. The lever must be removed and re-installed in the radial openings several times to perform a complete rotation of the barrel. The pivotal movement of the lever is restricted given the proximity of the trailer's frame that precludes complete rotational movements of the lever about the rotational axis of the winch's barrel. Repetitive installation, pivotal movement and removal of the lever slowly and progressively winds and increases tension in the belt.

The belts remaining in winches installed on road trailers are subject to poor road and weather conditions and must preferably be removed from the winches when they are not used. Removing the belts also prevents the belts from being stolen. In any case, removing the belts from winches and manually re-winding them back in a compact arrangement so that they are easily storable is a time consuming process. The winch is not really helpful for winding the belts for storage because it is not possible to remove a wound belts from the winch's barrel. Even if a wound belt could be removed from the barrel, the slow winch action would likely discourage the use of the winch to wind the belts.

Therefore, a system for reducing the time needed to actuate a winch has been felt over existing systems. There is also a need for a mechanism for winding unused belts for storage. These and other needs will likely become apparent for a person skilled in the art of winches in view of the forgoing description and the appended figures.

### SUMMARY OF THE INVENTION

More specifically, in accordance with the present invention, there is provided a winch tool adapted to continuously rotate the barrel of a winch installed on a road trailer.

In accordance with another aspect of the present invention, there is provided a winch tool adapted to efficiently wind a belt in a compact storable configuration that can be removed from the winch without unwinding the belt.

Another aspect of the present invention provides a winch tool that is removable from the winch when not in use.

One other aspect of the present invention provides a winch tool transforming a reciprocal rotation into a continuously rotational movement.

An aspect of the present invention provides a winch tool for actuating a winch, the winch comprising a winch frame; a barrel defining a rotation axis and being rotatably supported by the winch frame to allow rotation of the barrel about the rotation axis, the barrel having an external shape adapted to accommodate a belt wound thereon, the barrel having a first barrel end radially and axially accessible externally of the winch frame and a second barrel end, axially opposed to the first barrel end and axially accessible externally of the winch frame, the first barrel end having a substantially cylindrical exterior surface being disposed at a radius from the rotation axis; a barrel slot longitudinally disposed on the barrel and extending through the barrel; a radial opening disposed on the first barrel end and adapted to receive a lever to apply a rotational force on the barrel about the rotation axis, the radial opening being radial to the rotation axis of the barrel; and an axial opening disposed on the second barrel end, the axial opening being in communication with the barrel slot, the axial opening being disposed axially in respect to the rotation axis of the barrel; the tool comprising: a handle having a first end and a second end, the first end and the second end defining a longitudinal axis there between; a connector rotatably fastened to the first end of the handle; and a protrusion extending from the connector, the protrusion being configured to engage the radial opening of the barrel, a rotational movement of the connector to cause rotational movement of the barrel when the tool is connected to the barrel.

In another aspect, the present invention provides a tool for actuating a winch having a connector with a substantially semicircular shape adapted to enter in contact with the substantially cylindrical exterior surface of the first barrel end.

One other aspect of the present invention provides a winch tool adapted to engage the winch in a first direction and disengage the winch tool when the rotational movement of the connector about the rotational axis is in a second direction opposed to the first direction.

In yet another aspect, the present invention provides a connector laterally spaced from the longitudinal axis of the handle to prevent an interference between the connector and the handle when the connector rotates about the handle.

Another aspect of the present invention provides a winch tool further comprising a belt support having a cylindrical body defining a belt support axis; a belt receiving slot disposed along the belt support axis on the cylindrical body; and a fastener adapted to axially connect the cylindrical body of the belt support to the barrel of the winch so as to cause the cylindrical body of the belt support to rotate with the barrel when the belt support is connected to the winch and a rotational motion is applied to the barrel of the winch and wherein the fastener comprises: a retractable portion having a first end and a second end, the first end adapted to connect to the cylindrical body; and a pivotable connector slidably and pivotally connected to the second end of the retractable portion, the pivotable connector adapted to access the axial opening of the second barrel end, along the rotation axis, and pivot perpendicularly to the rotation axis of the barrel, to engage the barrel through the barrel slot to secure the belt support to the barrel, causing the belt support axis to be substantially coaxial with the rotation axis of the barrel when the belt support is connected to the winch.

An additional aspect of the present invention provides a tool for actuating a winch wherein, when the retractable portion is fastened with the cylindrical body of the belt support using a left handed threaded portion, the left handed thread securing the belt support to the winch by retracting the retractable portion toward the cylindrical body when the cylindrical body is rotated counter clockwise in respect with the retractable portion and the pivotable portion engages the barrel slot.

Another additional aspect of the present invention provides a tool for actuating a winch having a cylindrical body is adapted to wind a belt thereon and to remove a wound roll of belt from the cylindrical body by pulling the wound roll of belt along the rotation axis away from the winch.

An aspect of the present invention provides a winch tool comprising: a handle having a first end and a second end, the first end and the second end defining a longitudinal axis there between; a connector having a substantially semicircular shape and being rotatably fastened to the first end of the handle; and a protrusion extending from the connector toward an inside portion of the semicircular shape connector, the protrusion being configured to engage a barrel, a rotational movement of the connector to cause rotational movement of the barrel when the tool is connected to the barrel.

Yet another aspect of the present invention provides a method for rotating a winch, the method comprising: engaging a tool on a barrel of the winch; applying a mainly reciprocal motion to the tool; transferring the mainly reciprocal motion applied to the tool in a rotational movement on the winch; fastening a belt support to the winch; securing a belt on the belt support; winding the belt on the belt support; and removing the belt wound on the belt support without unwinding the wound belt.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a top-left perspective view of a winch tool according to a first embodiment of the invention;

FIG. 2A is a right side elevational view of the winch tool shown in FIG. 1;

FIG. 2B is a top plan view of the winch tool shown in FIG. 1;

FIG. 2C is a bottom-right side perspective view of the winch tool shown FIG. 1;

FIG. 3 is a perspective view of the winch tool shown in FIG. 1 when used with a winch on a road trailer;

FIG. 4 is a top plan view of a winch tool according to a second embodiment of the invention;

FIG. 5A is another top plan view of the winch tool shown in FIG. 4 with the retractable portion rotated 90°;

FIG. 5B is another top plan view of the winch tool shown in FIG. 4 with the body rotated 90°;

FIG. 6 is a left-front perspective view of a road trailer winch;

FIG. 7 is a front-left perspective view of the winch tool shown in FIG. 4 during installation of the winch of a road trailer;

FIG. 8 is a front elevational view of the winch tool of FIG. 7 during installation on a road trailer according to an embodiment of the present invention;

FIG. 9 is a front elevational view of the winch tool shown in FIG. 4 during installation of the winch of a road trailer;

FIG. 10 is a front elevational view of the winch tool shown in FIG. 4 installed on the winch of a road trailer; and

FIG. 11 is a perspective view of the winch tool shown in FIGS. 1 and 4 when used with the winch on a road trailer.

### DESCRIPTION OF ILLUSTRATIVE EMBODIMENTS

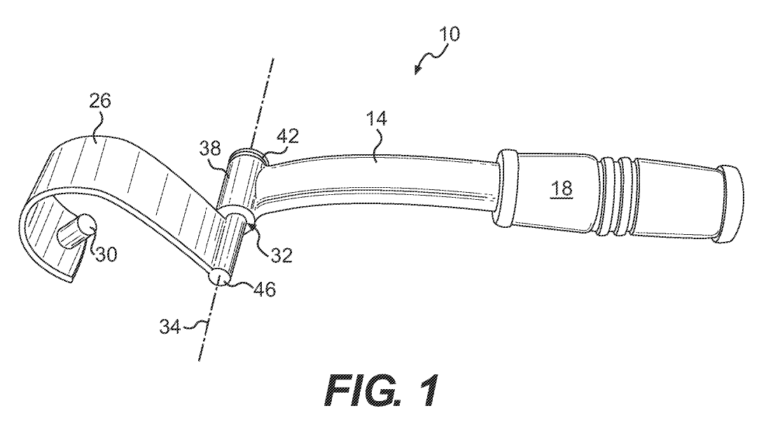

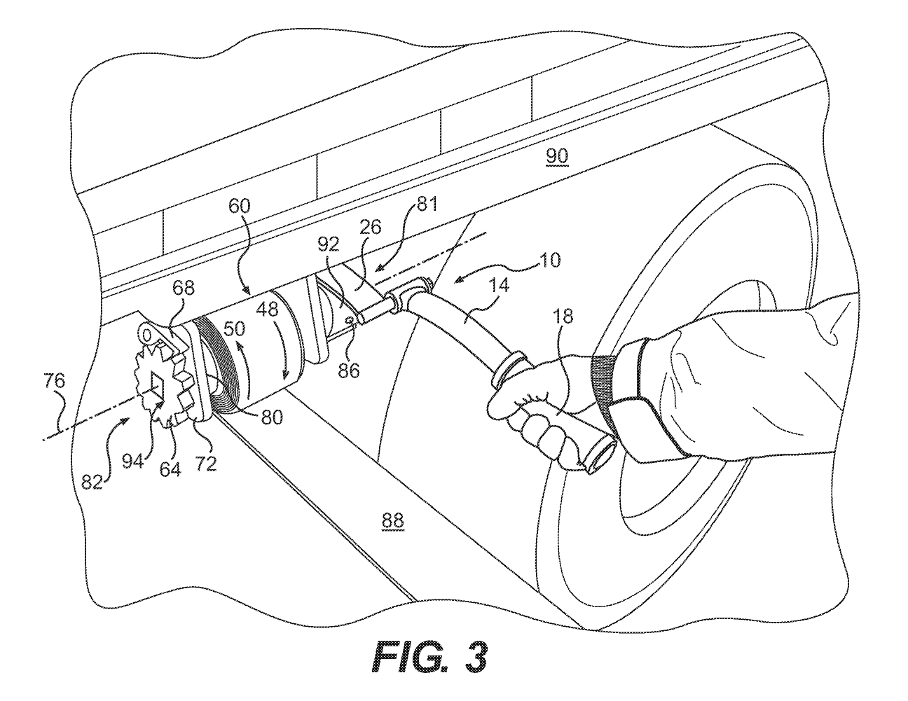

A tool 10 for rotating a winch 60 used to secure cargo on a flat bed trailer in the trucking industry is shown in FIG. 1. As shown in FIG. 3, the tool 10 connects to the winch 60 to efficiently wind a belt 88 thereon by continuously rotating the barrel 80 of the winch 60. The winch 60 will be discussed later.

The tool 10 includes a handle 14 having a grip 18 on one end and a cylinder 38, disposed perpendicularly to the handle 14, on the other end of the handle 14. The cylinder 38 defines a pivot axis 34. The cylinder 38 is adapted to receive an hollowed bushing 32 to reduce the friction inside the cylinder 38 and to prevent any friction noise. A spindle 46 is rotatably inserted inside the bushing 38 and is secured on the other side with a cap 42 to prevent the spindle 46 and the bushing from exiting the bore 32. Alternatively, the spindle 46 could be secured in place with a “C” clip, a snap ring or another means for locking a shaft in place while permitting rotational movements. This mechanical connection allows the spindle 46 to freely rotate in the bushing 32 about the pivot axis 34.

The spindle 46 rotatably interconnects the handle 14 with a connector 26. In the illustrative embodiment, the connector 26 is welded on the spindle 46 and is disposed on one lateral side of the handle 14 to allow uninterrupted rotational movement of the connector 26 about the pivot axis 34. The tool 10, when typically held by the grip 18, transforms a reciprocal movement of the handle 14 into a rotational movement of the connector 26. Once the connector 26 is secured to the barrel 80 of the winch 60 the continuous rotational movement of the connector 26 provides a continuous rotational movement to the winch 60 to wind a belt thereon. Conversely, repetitive pivotal movements are required when using a prior art lever.

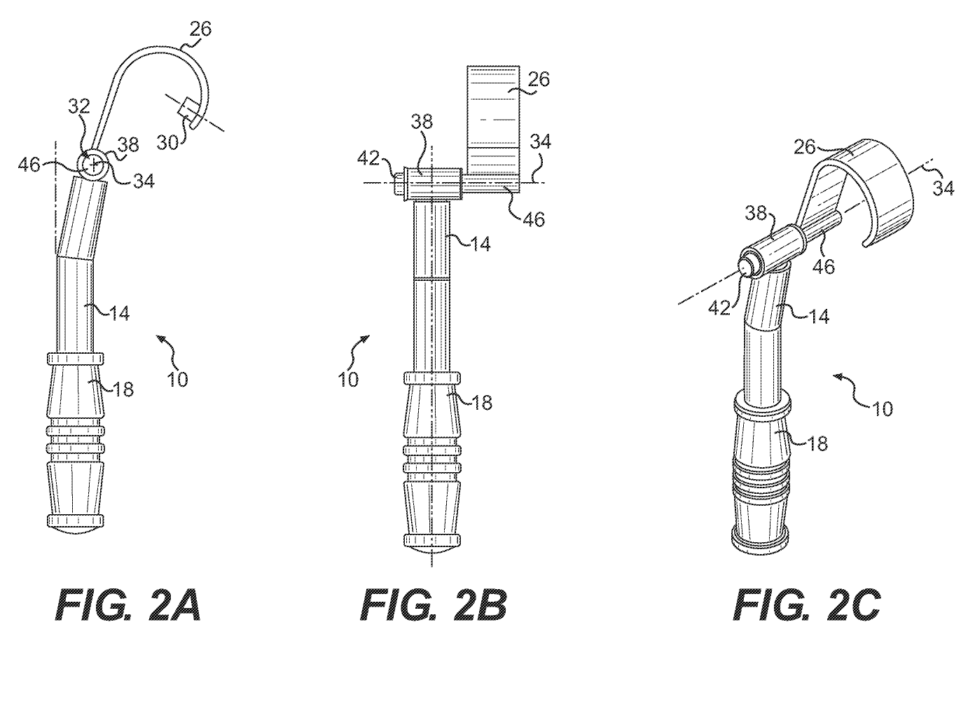

It can be appreciated from FIGS. 2A, 2B and 2C that the connector 26 has a semi-circular shape. The radius of curvature of the connector 26 approximately corresponds to the radius of the exterior cylindrical surface 92 of the first barrel end 81 of the winch 60 when the tool 10 is installed on the first barrel end 81 of the winch 60 as shown in FIG. 3. The radius of the internal surface of the connector 26 is preferably lightly larger than the radius of the exterior cylindrical surface 92 of the first end 81 of the barrel 80 to ensure easy installation (and removal) of the connector 26 to the first barrel end 81 as shown in FIGS. 1 and 2A. A protrusion 30 is disposed on the end of the connector 26, inside the connector's 26 semi-circular shape, for securing the tool 10 to the barrel 80 of the winch such that the rotational movement of the connector 26 is transmissible to the barrel 80.

The handle 14 and the connector 26 are preferably made of aluminum for strenght and light weight. Aluminum allows the handle 14 to be bent for improving the ergonomics of the tool 10. The cylinder 38 could also be made of aluminum and be directly welded to the handle 14. The protrusion 30, also preferably made of aluminium, is welded or fastened to the connector 26. All parts are anodized to protect the metal surface of each part of the tool 10. Alternatively, the handle 14 and the connector 26 could be made of nylon charged plastic or any other materials offering sufficient strenght without departing from the scope of the present invention.

With reference to FIG. 3, the winch 60 is generally mounted on the side of a trailer 90 to apply tension to the belt 88 for securing cargo load on the trailer 90. The winch 60 comprises a winch frame 72 operatively connecting the movable elements of the winch 60 to the trailer 90. The frame 72 of the winch 60 may be welded or fastened to the trailer 90. The later option offering more flexibility for positioning the winch 60 along the side of the trailer.

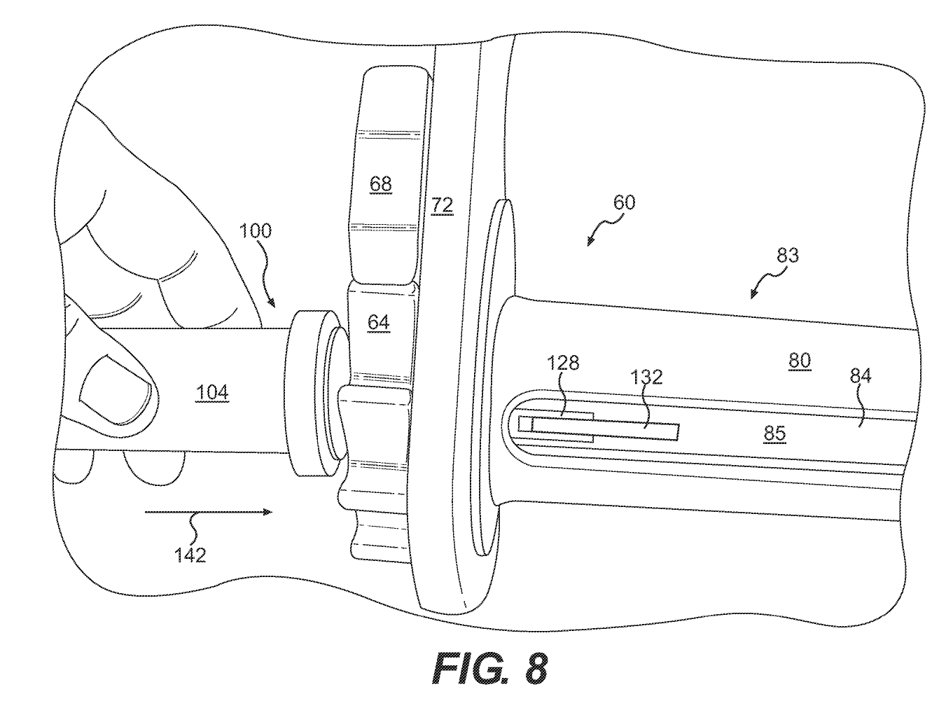

The frame 72 of the winch 60 includes two parallel members, each having an opening adapted for rotatably receiving a barrel 80 rotatable about axis 76. A slot 84 (not visible in FIG. 3 because of the belt 88 but is visible in FIG. 8) is longitudinally disposed along the barrel 80 and is sized such that the belt 88 can pass through the barrel 80. Excess of belt 88 can be removed by pulling the belt 88 trough the slot 84 before rotating the barrel 80 and starting winding the belt 88 thereon. The barrel 80 is preferably cylindrical to prevent tearing the belt 88 wound thereon.

The first barrel end 81 of the winch 60 is provided with an opening 86 radially extending there through to insert a prior art lever, rotate the barrel 80 and increase tension in the belt 88. The same opening 86 is used by the tool's protrusion 30 on the connector 26 to engage the barrel 80.

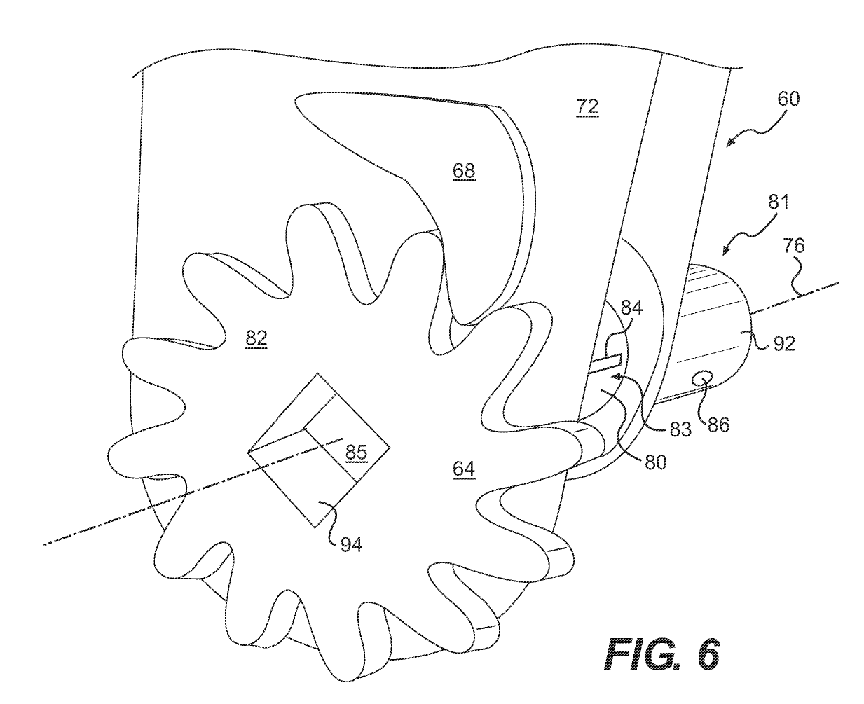

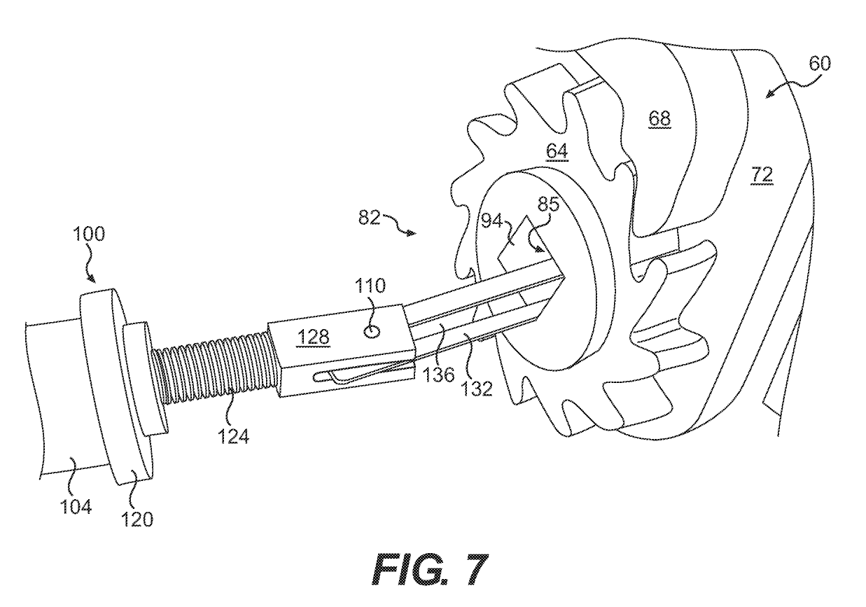

A ratchet-type mechanism is located on the second barrel end 82 disposed on the left side of the winch 60. The second barrel end 82 includes a ratchet gear 64 and a ratchet lock 68 to selectively prevents rotational movement of the barrel 80 in a first direction 48 while allowing free movement in the opposite direction 50. The ratchet lock 68 can be disengaged from the ratchet gear 64 to allow free rotation of the barrel 80 in both directions. The second barrel end 82 of the winch 60 further includes an axial opening 94 giving access to the hollowed internal portion 85 (illustrated on FIGS. 6 and 7) of the barrel 80 and the slot 84.

The protrusion 30 temporarily positions the connector 26 on the exterior cylindrical surface 92 of the first barrel end 81 such that the connector 26 and the handle 14 can generate a rotational movement of the barrel 80 about the axis 76. Once the connector 26 is installed over the exterior cylindrical surface 92 and the protrusion 30 is secured in one of the openings 86, the barrel 80 can rotate with the rotation of the connector 26 in the first direction 48. A user applying a reciprocal movement to the handle 14 will continuously rotate the barrel 80 of the winch 60 to wind the belt 88 thereon. Conversely, movement of the connector 26 in the opposite direction 50 will disconnect the protrusion 30 and the connector 26 from the first barrel end 81.

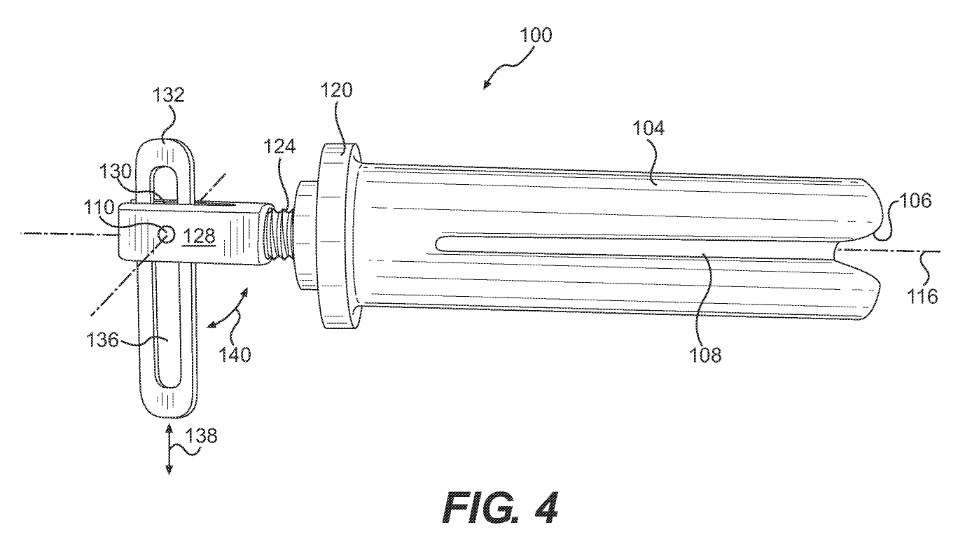

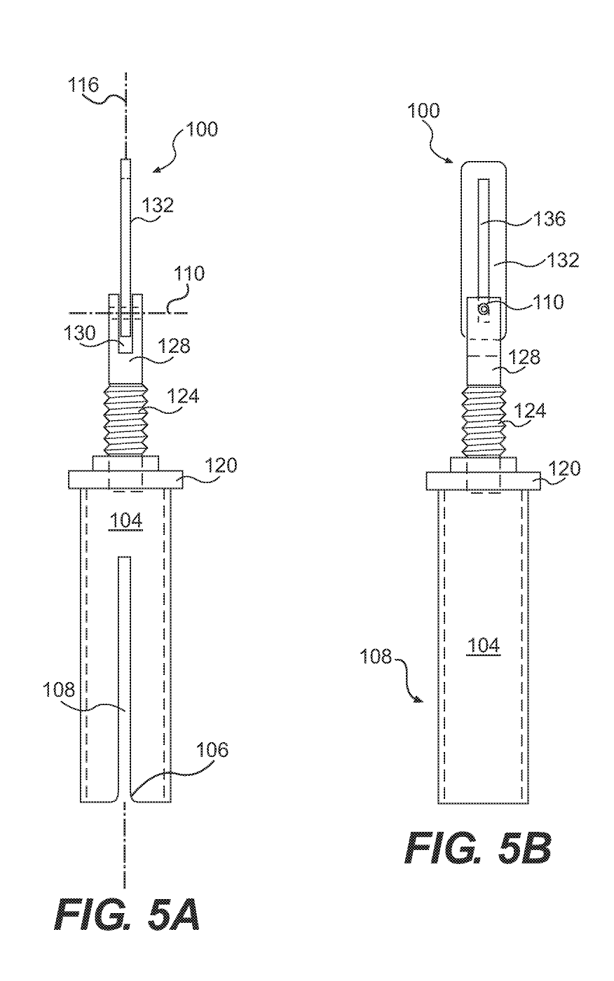

FIGS. 4, 5A and 5B depict another element of the tool. A belt support 100 adapted to be affixed to the second barrel end 82 of the winch 60 to wound a belt 88 thereon is illustrated. The belt support 100 is adapted to be installed outside the winch 60 so that the belt 88 wound on the belt support 100 can easily be removed for storage. It can be appreciated by a skilled reader from the illustrative embodiment that the belt support 100 is composed of three distinct parts: a body 104, a retractable portion 128 and a pivotable connector 132. The body is used to receive the belt 88 thereon. The retractable portion 128 is fasten into the body 104 to bind the belt support 100 to the winch 60. The retractable portion 128 has a threaded portion 124 on one end and a connector-receiving slot 130 on the opposite end. The connector-receiving slot 130 is disposed on the retractable portion 128 to receive the pivotable connector 132. The pivotable connector 132 has a slot 136 through which passes a pivot pin 110 locking the pivotable connector 132 to the retractable portion 128. The lever 132 is easily slidable in the lever-receiving slot 130 and is retained by a pivot pin 110 installed through the retracting portion 128 capturing the middle of the slot 136. The pivot pin 110 ensures free longitudinal movements 138 and angular movements 140 to the lever 132. The pivotable connector 132 is configured to engage the barrel 80 and secure the belt support 100 on the second barrel end 82. Preferably, the size of the lever-receiving slot 130 provides sufficient room for the lever 132 to make a complete rotation about the pivot pin 110 or at least to reach substantial alignment with the axis 116 suitable for engaging the second barrel end 82 of the winch 60. The slot 136 also limits the longitudinal movement 138 of the pivotable connector 110.

The body 104 further includes a cap 120 welded on one side to secure the threaded portion 124 of the retractable portion 128. The body 104 has an hollowed center and is provided with a radius 106 on each side of the slot 108 to prevent any damages to the belt 88. The slot 108 is sized and designed to receive a belt 88 in a preferably slidable fashion such that the belt 88 is easily installed and maintained in the slot 108. All parts are made of steel but could be made of another material without departing from the scope of the present invention.

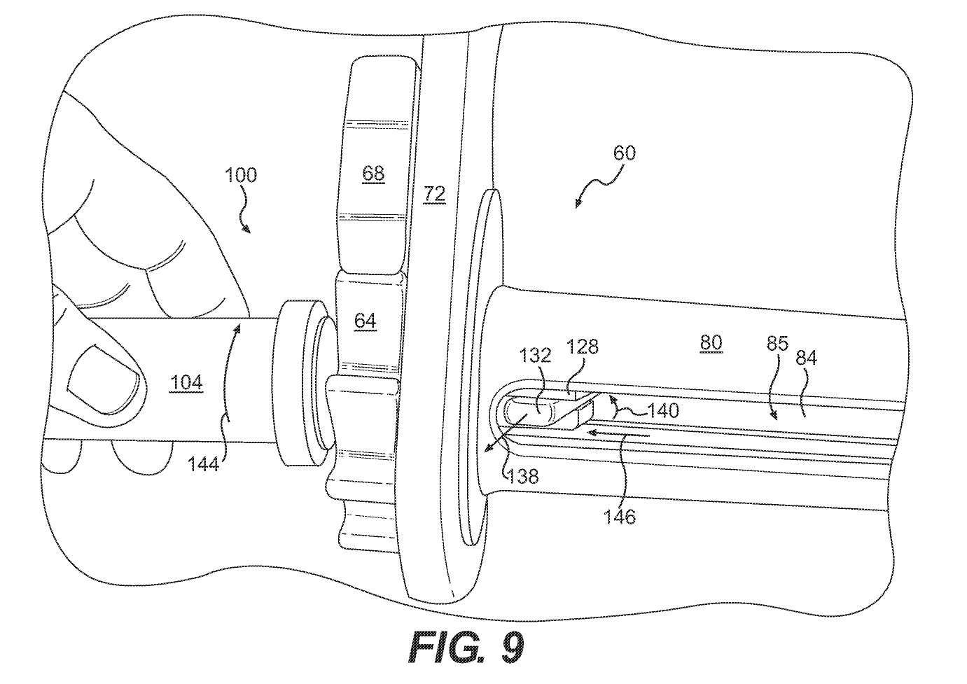

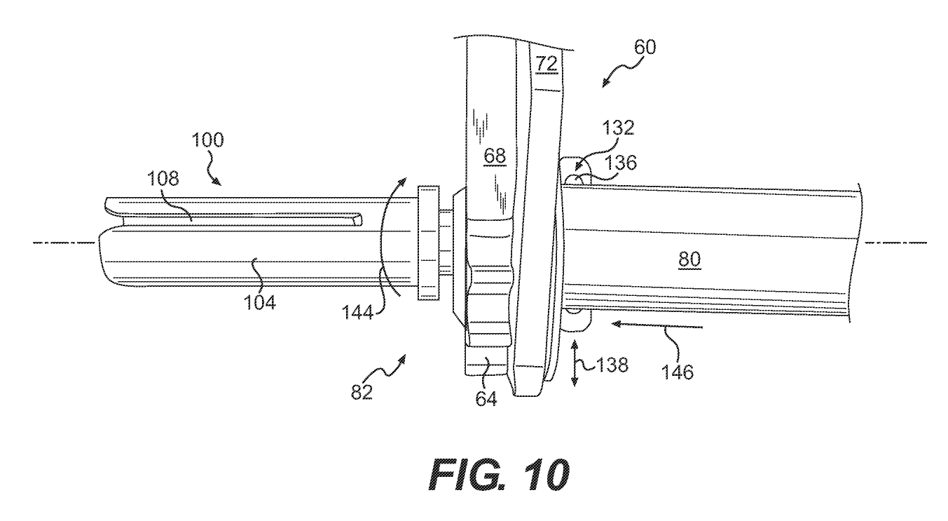

FIGS. 6 through 10 are illustrating the installation process of the belt support 100 to the second barrel end 82. The pivotable connector 132 is aligned with the insert 128 prior to its insertion in the axial opening 94 of the winch 60 as illustrated by arrow 142 in FIG. 8. More specifically, it can be appreciated from FIG. 8 that the lever 132 and the insert 128 are axially extended through the ratchet gear 64, the frame member 72 and the left side of the barrel 80. The pivotable connector 132 and a portion of the insert 128 become accessible from the slot 84 of barrel 80. As shown in FIGS. 8 and 9, the pivotable connector 132 is then manually rotated perpendicularly to the rotation axis 76 through the slot 84 as illustrated by arrow 140. The transversal positioning of the pivotable connector 132, as illustrated by arrow 138, evenly locate the pivotable connector 132 on each side of the barrel 80. The pivotable connector 132 has a length sufficient to prevent its exit through the axial opening 94 when the retractable portion 128 is retracted toward the body 104. Retracting translation illustrated by arrow 146 of the retractable portion 128 is caused by the rotation 144 of the body 104 acting on the left-handed threaded portion 124 of the retractable portion 128. When the retractable portion 128 gets closer to the body 104, the pivotable connector 132, still perpendicular to the axis 76, comes in contact with the internal surface of the barrel 80 and maintains the belt support 100 secured to the winch 60.

A left-handed thread 124 is used on the retractable portion 128 instead of a classic right-hand thread to avoid any undesired unscrewing of the retractable portion 128 during normal operation of the winch 60 with the belt support 100. The rotational movement of the winch 60 and the tension on the strap 88 winding on the body 104 would force a right-hand thread to unscrew. Using a left-hand threaded portion 124 on the retractable portion 128 ensures the belt support 100 remains firmly connected to the winch 60 when in operation.

The belt support 100 is used to efficiently wind a belt 88 removed from the winch 60 for storage. When the strap is completely removed from the winch 60, the tip of the belt 88 is inserted in the slot 108. Radiuses 106 (shown on FIG. 4) disposed on the end of the slot 108 facilitate the longitudinal insertion of the strap 88 in the slot 108. The length of the slot 108 is preferably proportional to the width of the belt 88 and the hollowed center of the body 104 offers enough space to house a portion of the strap 88 therein. As previously mentioned, the width of the slot 108 is selected according to the desired interference with the belt 88. A slight interference would ensure the tip of the belt 88 will not slide out of the slot 84 during the winding process. More than one slot 108 can be disposed on the body 104 to provide many different options where to install the belt 88 or to pass the belt 88 through the body 104.

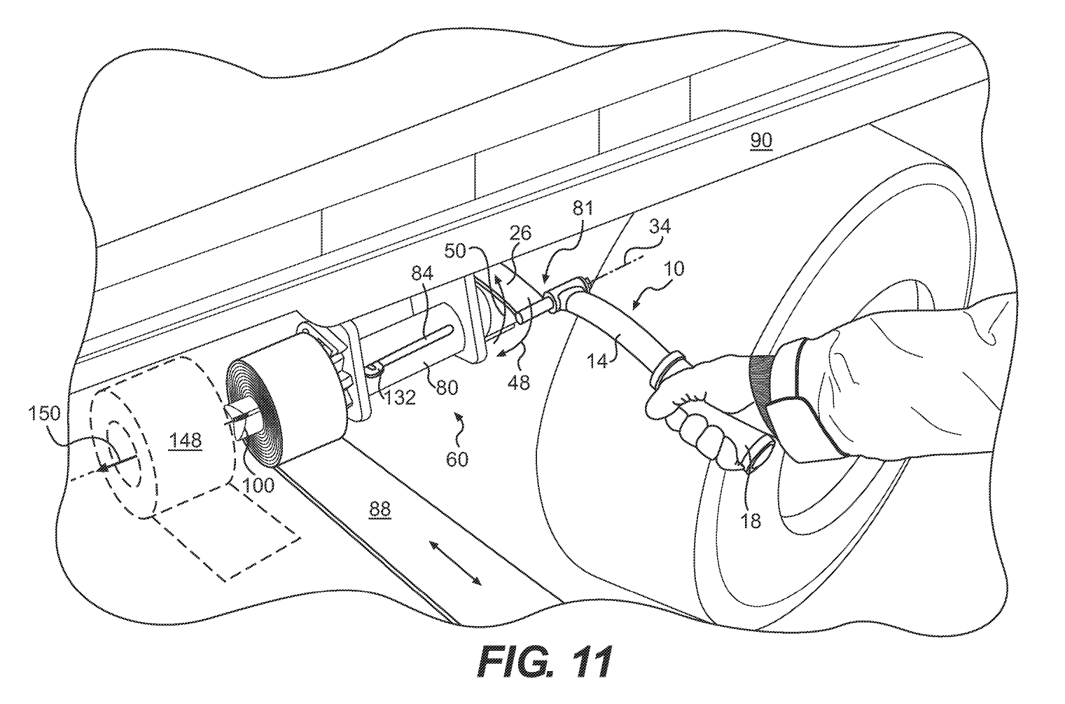

FIG. 11 illustrates how the tool 10 and the belt support 100 cooperate with the winch 60. The tool 10 actuates the barrel 80 of the winch 60 and also rotates, according to arrow 48 the belt support 100, winding the belt 88 thereon. It can be appreciated from FIG. 11 that the connector 26 clears the lower portion of the trailer's frame 90 and makes complete revolutions about axis 76 (i.e. the handle 14 analogously acts like a connecting rod on a crankshaft thus transmitting rotational motion to the connector 26).

The belt 88 is rapidly wound on the belt support 100 by using the tool 10. The roll 148 of belt 88 is removed from the body 104 by axially pulling the wound roll 148 of belt 88 away from the winch 60 as illustrated by arrow 150. The diameter of the body 104 does not increase toward the side opposed to the cap 120 (shown on FIG. 4) to promote easy removal of the roll 148 of belt 88 by simply axially sliding off the roll from the body 104. A slight progressive reduction in the body 104 diameter would facilitate the removal of the roll of belt 88. The compact roll 148 of belt 88 can be conveniently stored once removed from the body 104. Another belt is installed in the slot 108 of the belt support body 104 to wind the belt 88 by repeating the same previously described actions. This method of winding belts is much faster than manually winding the belts removed from the winch 60.

The embodiment described herein are for illustrative purpose only and does not limit the scope of the present specification to a curved connector 26 connecting an end of the winch 60. All other structures suitable for connecting the handle 12 with the barrel 80 for efficiently rotating the barrel 80 are considered within the scope of the present application.

Although the present invention has been described hereinabove by way of specific embodiments thereof, it can be modified, without departing from the spirit and nature of the subject invention as defined in the appended claims.

What is claimed is:

1. A tool for actuating a winch, the winch comprising:
i) a winch frame;
ii) a barrel defining a rotation axis and being rotatably supported by the winch frame to allow rotation of the barrel about the rotation axis, the barrel having an external shape adapted to accommodate a belt wound thereon, the barrel having a first barrel end radially and axially accessible externally of the winch frame and a second barrel end, axially opposed to the first barrel end and axially accessible externally of the winch frame, the first barrel end having a substantially cylindrical exterior surface being disposed at a radius from the rotation axis;
iii) a barrel slot longitudinally disposed on the barrel and extending through the barrel;
iv) a radial opening disposed on the first barrel end and adapted to receive a lever to apply a rotational force on the barrel about the rotation axis, the radial opening being radial to the rotation axis of the barrel; and
v) an axial opening disposed on the second barrel end, the axial opening being in communication with the barrel slot, the axial opening being disposed axially in respect to the rotation axis of the barrel;
the tool comprising:
a. a handle having a first end and a second end, the first end and the second end defining a longitudinal axis there between;
b. a connector rotatably fastened to the first end of the handle; and
c. a protrusion extending from the connector, the protrusion being configured to engage the radial opening of the barrel, a rotational movement of the connector to cause rotational movement of the barrel when the tool is connected to the barrel.

2. The tool for actuating a winch as claimed in claim 1, wherein a mainly reciprocal movement of the second end of the handle causes the rotational movement of the connector.

3. The tool for actuating a winch as claimed in claim 1, wherein the connector has a substantially semicircular shape adapted to enter in contact with the substantially cylindrical exterior surface of the first barrel end.

4. The tool for actuating a winch as claimed in claim 1, wherein the protrusion engages the radial opening when the rotational movement of the connector about the rotational axis is in a first direction and disengages the protrusion from the radial opening when the rotational movement of the connector about the rotational axis is in a second direction opposed to the first direction.

5. The tool for actuating a winch as claimed in claim 1, wherein the connector is rotatably connected to the first end of the handle about a pivot axis disposed perpendicular to the longitudinal axis of the handle.

6. The tool for actuating a winch as claimed in claim 5, wherein the connector is laterally spaced from the longitudinal axis of the handle to prevent an interference between the connector and the handle when the connector rotates about the pivot axis.

7. The tool for actuating a winch as claimed in claim 5, wherein the handle comprises a bushing disposed on the first end of the handle, the bushing having a bore coaxial with the pivot axis.

8. The tool for actuating a winch as claimed in claim 5, wherein the connector and the handle can be disassembled.

9. The tool for actuating a winch as claimed in claim 1, wherein the second end of the handle comprising a grip to facilitate the manipulation of the tool by a user.

10. The tool for actuating a winch as claimed in claim 1, wherein the handle comprises a deflection in the longitudinal axis.

11. The tool for actuating a winch as claimed in claim 1, wherein one of the handle and the connector is made of aluminium.

12. The tool for actuating a winch as claimed in claim 1, further comprising a belt support comprising
a. a cylindrical body defining a belt support axis;
b. a belt receiving slot disposed along the belt support axis on the cylindrical body; and
c. a fastener adapted to axially connect the cylindrical body of the belt support to the barrel of the winch so as to cause the cylindrical body of the belt support to rotate with the barrel when the belt support is connected to the winch and a rotational motion is applied to the barrel of the winch.

13. The tool for actuating a winch as claimed in claim 12, wherein the fastener comprises:
a. a retractable portion having a first end and a second end, the first end adapted to connect to the cylindrical body; and
b. a pivotable connector slidably and pivotally connected to the second end of the retractable portion, the pivotable connector adapted to access the axial opening of the second barrel end, along the rotation axis, and pivot perpendicularly to the rotation axis of the barrel, to engage the barrel through the barrel slot to secure the belt support to the barrel, causing the belt support axis to be substantially coaxial with the rotation axis of the barrel when the belt support is connected to the winch.

14. The tool for actuating a winch as claimed in claim 13, wherein, when the retractable portion is fastened with the cylindrical body of the belt support using a left handed threaded portion, the left handed thread securing the belt support to the winch by retracting the retractable portion toward the cylindrical body when the cylindrical body is rotated counter clockwise in respect with the retractable portion and the pivotable portion engages the barrel slot.

15. The tool for actuating a winch as claimed in claim 13, wherein the cylindrical body comprises an hollowed center, the belt receiving slot extending through at least one side of the cylindrical body.

16. The tool for actuating a winch as claimed in claim 13, wherein the belt receiving slot is sized and designed to slidably engage a belt.

17. The tool for actuating a winch as claimed in claim 13, wherein the cylindrical body is adapted to wind a belt thereon and to remove a wound roll of belt from the cylindrical body by pulling the wound roll of belt along the rotation axis away from the winch.

18. The tool for actuating a winch as claimed in claim 14, wherein the rotative activation of the winch with the tool in the first direction further screws the retractable portion to the cylindrical body and rotates the belt support member to wind the belt thereon.

19. A tool comprising:
a. a handle having a first end and a second end, the first end and the second end defining a longitudinal axis there between;
b. a connector having a substantially semicircular shape and being rotatably fastened to the first end of the handle; and
c. a protrusion extending from the connector toward an inside portion of the semicircular shape connector, the protrusion being configured to engage a barrel, a rotational movement of the connector to cause rotational movement of the barrel when the tool is connected to the barrel.

20. A method for rotating a winch, the method comprising:
a. engaging a tool on a barrel of the winch;
b. applying a mainly reciprocal motion to the tool; and
c. transferring the mainly reciprocal motion applied to the tool in a rotational movement on the winch.

21. The method for rotating a winch of claim 20, comprising:
a. fastening a belt support to the winch;
b. securing a belt on the belt support;
c. winding the belt on the belt support; and
d. removing the belt wound on the belt support without unwinding the wound belt.
